(19) United States
(12) Patent Application Publication
(10) Pub. No.: US 2022/0390895 A1
(43) Pub. Date: Dec. 8, 2022

(54) INCOHERENT COLOR HOLOGRAPHY LATTICE LIGHT-SHEET (ICHLLS)

(71) Applicants: THE BOARD OF TRUSTEES OF THE UNIVERSITY OF ILLINOIS, Urbana, IL (US); THE ARIZONA BOARD OF REGENTS FOR AND ON BEHALF OF NORTHERN ARIZONA UNIVERSITY, Tucson, AZ (US)

(72) Inventors: Mariana Camelia Potcoava, Lakewood, CO (US); Simon Trevor Alford, Chicago, IL (US); Christopher John Mann, Flagstaff, AZ (US); Jonathan James Art, Chicago, IL (US)

(21) Appl. No.: 17/883,325

(22) Filed: Aug. 8, 2022

Related U.S. Application Data
(63) Continuation-in-part of application No. PCT/US2021/017102, filed on Feb. 8, 2021.
(60) Provisional application No. 62/971,081, filed on Feb. 6, 2020.

(51) Int. Cl. G03H 1/06; G03H 1/12

(52) U.S. Cl. CPC G03H 1/06; G03H 1/12; G03H 2001/005

(57) ABSTRACT

A method and system for performing incoherent color holographic microscopy imaging using light of various wavelengths, including modulating radiation at each wavelength to form two beams and detecting their intensity at a detector. The two beams include phase information that is retrieved from the phase shifted intensity recorded at the detector and holographic information is determined from the detected modulation of the two beams for each color. A processor is configured to receive the holographic information via a signal generated by the detector and the processor further generates a three-dimensional image of a target.

### CROSS-REFERENCE TO RELATED APPLICATIONS

This application is a continuation-in-part of International Patent Application No. PCT/US2021/017102, filed on Feb. 8, 2021, and claims the benefit of priority of U.S. Provisional Application 62/971,081 filed on Feb. 6, 2020, each of which is incorporated by reference herein in its entirety and for all purposes.

### STATEMENT OF GOVERNMENT INTEREST

This invention was made with government support under grant number R21 DC017292 awarded by The National Institutes of Health (NIH). The government has certain rights in this invention.

### TECHNICAL FIELD

The present disclosure relates to microscopy systems, and specifically to holographic color optical microscopy.

### BACKGROUND

Microscopy is a useful tool for imaging of a wide variety of samples, structural features, and objects that cannot be resolved by the unaided human eye. Different microscopy techniques are often employed for imaging of different targets. For example, fluorescent microscopy is often used to image biological samples and tissues, while scanning electron microscopy is often used to image nanoscale features and particles. Many microscopy techniques provide intense excitation radiation to the target to be imaged, which may compromise the function of biological tissues, cause photobleaching of samples, or otherwise degrade the structural integrity or electrical properties of the target. In some instances low intensity microscopy may be used to image sensitive samples and materials, but low intensity techniques require long image capture times, which are not feasible for imaging biological processes, fabrication processes (e.g., atomic layer deposition, or another fabrication to be monitored), or any changes of a sample in real time.

Light sheet microscopy is a high speed, low excitation intensity, 3D imaging technique. During light sheet microscopy, a plane of a material is illuminated using a sheet of light, and a microscope objective is configured to view the plane from an orthogonal direction as compared to the illumination. While light sheet microscopy provides advantages over other known microscopy techniques, excitation light sheets disperse rapidly in refractive tissue, which limits the penetration depth of a target or sample material. A reduced penetration depth is undesirable for many imaging applications including in live cell imaging in which the low excitation intensities of light sheets provide a major advantage, but in which the substrate can be strongly refractive. Further, a reduced penetration depth results in a loss of three-dimensional imaging information, which results in low contrast images of three-dimensional objects and the inability to resolve fine three-dimensional features. Further, if three-dimensional imaging is needed, additional mechanical components and optics may be required to obtain multiple images to generate an adequate three-dimensional image.

One light sheet microscopy approach, known as Lattice Light-Sheet Microscopy (LLSM), uses a convergent lattice of Bessel beams to generate the light sheet. In LLSM the excitation is confined to a plane defined by a lattice of intersecting Bessel beams that self-reinforce as they project through a target. A reflected beam is then viewed orthogonally as compared to the propagation of the excitation, allowing low excitation intensity illumination of planes to be viewed rapidly in sequence with little photobleaching or interacting with the target. The self-reinforcing nature of the Bessel beams increases the penetration depth as compared to other light sheet microscopy techniques. Nevertheless, LLSM is still limited to an imaging depth of approximately 100 μm in live tissue due to optical distortions. Attempts at improving the penetration depth have employed additional optics that has increased the penetration depth to around 200 μm. However, the required additions are technically challenging and require very expensive equipment. Further, imaging capabilities using LLS are limited when moving bulky detection objectives and not practical for many applications (e.g., biological and tissue imaging) because motors and translation stages have limited ranges of motion, and the target may not withstand the motion of the moving objective and optics. Additionally, the deeper penetration depths allow for dispersion and distortion of the lattice to compound with greater distortion due to the penetration of the target. While advances in microscopy techniques have allowed for the imaging of a wide-variety of targets, current methods still suffer from multiple drawbacks such as requiring complex optical setups, high intensity excitation radiation, long image acquisition times, and expensive equipment, among others.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, there is a method for performing holographic microscopy. The method includes providing, to a modulator, radiation having a (i) phase, (ii) amplitude, and (iii) Poynting vector, modulating, by the modulator, the phase of the radiation to generate a plurality of beams, and detecting, at a detection plane of a detector module, the plurality of beams. The method further includes generating, by the detector module, a signal indicative of an interference pattern of the plurality of beams, and generating, by a processor, a holographic image from the signal indicative of the interference pattern.

In embodiments, the modulator is a spatial light modulator. In some embodiments, the radiation includes incoherent radiation. Further, in embodiments, the plurality of beams includes two beams have a phase offset of 0°, 90°, 180°, or 270° from each other. In embodiments, the method further includes collecting, by a microscope objective positioned at a first distance from the sample, the radiation from a sample and altering, by an actuator, the distance between the microscope objective and the sample from the first distance to a second distance, wherein the second distance is a different distance than the first distance; and collecting, by the microscope objective positioned at the second distance, the radiation from the sample.

In another aspect, there is a microscopy system including a source of radiation configured to provide radiation, the radiation having a (i) phase, (ii) amplitude, and (iii) Poynting vector, the Poynting vector having a direction indicative of a direction of propagation of the radiation. A modulator, disposed along the direction of the Poynting vector, is configured to modulate a phase of the radiation to generate a plurality of beams. A detector module, disposed along the direction of the Poynting vector, is configured to detect, at a detector plane of the detector module, the plurality of beams, and is further configured to generate a signal indicative of an interference pattern of the plurality of beams. A processor is communicatively coupled to the detector module, and is further configured to receive the signal indicative of the interference pattern, and to generate a holographic image from the signal.

### BRIEF DESCRIPTION OF THE DRAWINGS

FIG. 1 is a schematic diagram of an embodiment of a holographic microscopy apparatus for performing incoherent holographic microscopy lattice light-sheet (IHLLS) imaging.

FIG. 2 is a flow diagram of a method for performing IHLLS imaging.

FIG. 3A is a schematic diagram of an optical layout for an IHLLS system illustrating the beam of a single diffractive lens configuration (IHLLS 1L).

FIG. 3B is a schematic diagram of an optical layout for an IHLLS system illustrating the first beam of a two-beam configuration, generated with two diffractive lenses, (IHLLS 2L).

FIG. 3C is a schematic diagram of an optical layout for an IHLLS system illustrating the second beam of a two-beam configuration, generated with two diffractive lenses, (IHLLS 2L).

FIG. 4A is a lattice light sheet (LLS) image of a resolution target (USAF 1951), group 7, element 6, using white light.

FIG. 4B is an incoherent tomography LLS image, with one diffractive lens superimposed on a spatial light modulator (IHLLS 1L), of a resolution target (USAF 1951), group 7, element 6, using white light.

FIG. 4C is a plot of the normalized image intensity, along the dashed line, for group 7 of the resolution target according to the images of FIGS. 4A and 4B.

FIG. 4D is a plot of the normalized image intensity, along the dashed line, for group 7, element 6 of the resolution target according to the images of FIGS. 4A and 4B.

FIG. 5A is a tomographic image, obtained by a conventional LLS system, of 500 nm fluorescent beads.

FIG. 5B is a tomographic image, obtained by an IHLLS single lens system, of 500 nm fluorescent beads.

FIG. 5C is a tomographic image, obtained by a conventional LLS system, of 200 nm fluorescent beads.

FIG. 5D is a tomographic image, obtained by an IHLLS single lens system, of 200 nm fluorescent beads.

FIG. 6A is an array of holographic images, obtained by a two-lens IHLLS system, of 500 nm fluorescent beads.

FIG. 6B is an array of holographic images, obtained by a two-lens IHLLS system, of 200 nm fluorescent beads.

FIG. 7A is an image of maximum composite projection of all positions of a z-galvonometer for imaging of 500 nm fluorescent beads.

FIG. 7B is an image of maximum composite projection of all positions of a z-galvonometer for imaging of 200 nm fluorescent beads.

FIG. 8A presents the transverse full-width at half-maximum (FWHM) values for images obtained by the conventional LLS, IHLLS 1L, and IHLLS 2L systems for 500 nm fluorescent beads.

FIG. 8B presents the transverse full-width at half-maximum (FWHM) values for images obtained by the conventional LLS, IHLLS 1L, and IHLLS 2L systems for 200 nm fluorescent beads.

FIG. 9 is an array of images of a target neuron, with each image obtained by one of conventional LLS, single lens IHLLS, and two-lens IHLLS systems.

FIG. 10 is a schematic diagram of an embodiment of a holographic microscopy apparatus for performing ICHLLS imaging using a plurality of excitation wavelengths.

FIG. 11 is a flow diagram of a method for generating diffractive lenses for superimposing onto a modulator.

FIG. 12 is a flow diagram of a method for generating dual superimposed diffractive lenses for performing multi-wavelength holography.

FIG. 13A an image of a neuron obtained using conventional LLS with two radiation wavelengths.

FIG. 13B is an image of a neuron obtained using multi-wavelength IHLLS with one diffractive lens superimposed on a modulator.

FIG. 13C is an image obtained using multi-wavelength IHLLS with two diffractive lenses superimposed on a modulator.

FIG. 14A is an image of a neuron obtained using multi-wavelength IHLLS providing 488 nm radiation to a sample.

FIG. 14B is an image of a neuron obtained using multi-wavelength IHLLS providing 561 nm radiation to a sample.

FIG. 14C is an image of a neuron obtained using multi-wavelength IHLLS generated by combining the images of FIGS. 14A and 14B.

Advantages will become apparent to those skilled in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

An incoherent holographic microscopy detection method and associated system are disclosed. The microscopy technique employs incoherent holographic microscopy lattice light-sheet (IHLLS) imaging to generate three-dimensional images of a target. The method employs Fresnel incoherent correlation holography to generate the three-dimensional images. The incoherent imaging disclosed utilizes a scanning geometry with two imaging planes, reduces optical design and hardware complexity, and overall system cost as compared to other microscopy techniques. Further, the disclosed system and method allows for the generation of amplitude and phase three-dimensional images using numerical processing by digital holography.

Digital holography is a powerful three-dimensional (3D) imaging tool. In digital holography the 3D image of a sample volume is formed from determining and analyzing a complex-amplitude distribution of radiation. Most common digital holography techniques use coherent light, such as lasers, to illuminate a sample or target to image the target. The use of coherent light introduces noise from speckle and spurious interference, which limits the imaging resolution and contrast. Further, coherent light sources often provide high intensity excitation radiation which may damage, or otherwise be unsuitable, for imaging of certain materials (e.g., biological samples, tissues, electrically active materials, etc.). The incoherent holographic imaging described herein employs spatially incoherent light (e.g., fluorescent light, black body radiation, etc.) to form holograms and produce images with improved spatial resolution than conventional microscopy techniques.

The incoherent holography method and system disclosed utilizes a modified dual-lens Fresnel incoherent correlation holography technique to produce a complex hologram and to provide a reconstruction distance needed for the reconstruction of the hologram. As described herein, the IHLLS system exhibits a significant contrast improvement over other imaging techniques for imaging of beads and neuronal structures within a biological test sample, as well as quantitative phase imaging. The IHLLS also demonstrates improved transverse imaging resolutions as compared to traditional lattice light-sheet technique.

The disclosed system and method enable the generation of 3D holographic images without requiring the movement of any of a sample stage or detection microscope objective, which simplifies the system setup and reduces the need for mechanical components and controls. Further, by moving only galvanometric mirrors, the described system provides increased resolution and image accuracy as compared to known glass-optics LLS schemes. While not requiring the movement of system components, it may be desirable to perform a deeper volumetric reconstruction for a holographic image, and as such, the described IHLLS may include mechanical components. IHLLS allows for holographic volume reconstruction from fewer position displacements than other holography 3D imaging techniques reducing volume image acquisition time. For example, the described system may reconstruct a holographic image using 9 spatial positions of an objective, whereas traditional methods would require nearly 300 positions for the same objective. Capturing and reconstructing images at multiple objective positions may also improve axial resolution to achieve better localization of ample points and improve axial resolution of images. The optical and mechanical design of the described IHLLS system expands the applicability of lattice light-sheet systems and could open entirely new imaging modalities in all light sheet imaging instruments. The incoherent holography configuration described could be added as an accessory, or as an add-on feature, to any imaging system that uses Bessel or Gaussian beams for scanning and imaging.

Use of a single wavelength band excitation radiation is described for IHLLS, and further, incoherent color holography lattice light-sheet (ICHLLS) using multiple wavelengths of excitation radiation is also described. While a two color (i.e., two wavelength) ICHLLS is demonstrated, the systems described herein are readily scalable to image using four or more colors of radiation. The multi-color technique uses self-interference properties of fluorescence emitted from a sample. Multiple (e.g., two, three or four, as needed) interference patterns are generated at different phase shifts to create Fresnel holograms of a three-dimensional (3D) sample. To implement the multi-color technique, a spatial light modulator (SLM) must be modified to actively control dual diffractive lenses at two colors, while providing phase-shifts to each color sequentially. One or more galvonometric actuators are physically coupled to an LLS to shift a position of the LLS, and therefore change the probing location in the z-direction (i.e., along axis of optical propagation) of the sample. Each phase-shifted image for each lens is repeated at each individual galvonometric scanning level. The described ICHLLS technique enables faster 3D phase and amplitude imaging without moving either a sample stage or detection objective. Additionally, the ICHLLS disclosed herein enables extended imaging fields-of-vies (FOVs) of 208×208 mm² or greater, at extended imaging depths.

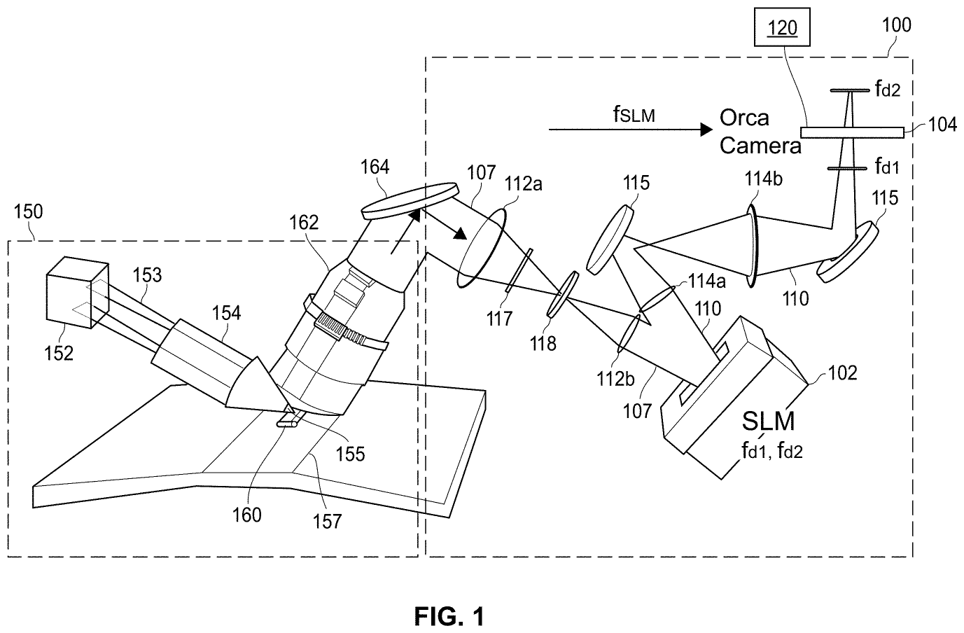

FIG. 1 is a schematic diagram of an embodiment of a holographic microscopy detection apparatus 100 for performing IHLLS as described herein. The holographic microscopy apparatus 100 includes a modulator 102 and a detector module 104. Radiation 107 is provided to the modulator 102 by a source of radiation, and the modulator 102 modulates the radiation 107 to generate a plurality of beams 110 from the radiation 107. The radiation 107 may be incoherent radiation that has a phase, amplitude, wavelength, and a Poynting vector indicative of the propagation direction of the radiation 107. In embodiments, the radiation 107 may be emitted continuous wave radiation or pulsed radiation before reaching the modulator, and the modulated plurality of beams 110 may be continuous or pulsed beams. The plurality of beams 110 is illustrated in FIG. 1 as a single beam for visual clarity, generated by two diffractive lenses superimposed on the modulator, referred to and further described herein as IHLLS 1L, and with randomly selected pixels on the modulator, referred to and further described herein as IHLLS 2L. As used herein, “superimposing” elements onto the modulator should be understood to mean programming of the modulator to provide amplitude and phase profiles to a beam incident on the active area of the modulator. The modulator 102 can then optically modify a beam, or beams of radiation to focus a beam, defocus abeam, alter a phase profile of the beam, alter a beam or wavefront shape, etc., for performing spatial and phase manipulate of a wavefront or beam of radiation. In implementations, each beam of the plurality of beams may co-propagate along a direction of a same Poynting vector, or beams of the plurality of beams 110 may propagate along different Poynting vectors. The plurality of beams 110 may include two beams, three beams, four or more beams with at least two of the beams of the plurality of beams 110 being spatiotemporally overlapped. At least two of the beams of the plurality of beams 110 must be partially, or entirely, spatiotemporally overlapped to generate an interference pattern between the overlapped beams.

The detector 104 is disposed along a propagation direction of the plurality of beams 110 (e.g., along one or more Poynting vectors of a beam of the plurality of beams), with the detector 104 configured to detect the interference pattern of the overlapped beams. The detector 104 may include one or more of a CMOS detector, a charge-coupled device (CCD), one or more photodiodes or photodiode arrays, a photovoltaic detector, a photomultiplier tube, a metal-oxide-semiconductor (MOS) capacitor, or an infrared sensor. The detector 104 is configured to generate a signal indicative of the detected interference pattern, and to provide the generated signal to a processor 120 for performing hologram generation, hologram reconstruction in amplitude and phase, and image processing. Further, the processor 120 may be configured to perform any required processing, calculations, or functions described herein to generate a holographic image.

In embodiments, the holographic microscopy apparatus 100 may include additional optical elements for performing wavelength filtering, polarization filtering, reflection, magnification, lensing, beam splitting, amplitude modulation, phase modulation, or for performing another optical process. In the embodiment illustrated in FIG. 1, the holographic microscopy apparatus 100 includes a first lens 112a and a second lens 112b configured to operate together as a telescope to magnify, or demagnify, the radiation 107. It may be desirable to increase or decrease the size of a wavefront of the radiation 107 according to the size of the wavefront 107 as it enters the holographic microscopy apparatus 100, and/or according to a size of an active area of the modulator 102. The active area of the modulator 102 is an area of the modulator 102 that actively modulates the phase and/or amplitude of the radiation 102. To prevent loss of radiation 107 it may be desirable for the first and second lenses 112a and 112b to magnify the wavefront of the radiation 107 to a size that is equal to, or smaller than, the active area of the modulator 102. While the first and second lenses 112a and 112b are described herein as magnifying the radiation 107, other elements may be employed to magnify the radiation 107. For example, a mirror, spatial light modulator, telescope, objective, or other magnifying element may be used to magnify the radiation 107.

The holographic microscopy apparatus 100 may further include a third lens 114a and a fourth lens 114b configured to operate together as a telescope to magnify the plurality of beams 110. In embodiments, it may be desirable to increase or decrease the size of one or more beams of the plurality of beams 110 according to the size of a detection area of the detector module 104, and/or the size of the active area of the modulator 102. The detector module 104 may include one or more sensors that have defined detection areas for detecting one or more of the beams of the plurality of beams 110, and/or for detecting interference between beams of the plurality of beams 110. To prevent loss of radiation 107, it may be desirable to for the third and fourth lenses 114a and 114b to magnify one or more beams of the plurality of beams 110 to a transverse size that is equal to, or smaller than an overall detection area of the detector module 102 (i.e., the combined detection area of the one or more sensors of the detection module 104). While the third and fourth lenses 114a and 114b are described herein as magnifying the plurality of beams 110, other elements may be employed to magnify the plurality of beams 110. For example, a mirror, spatial light modulator, telescope, objective, or other magnifying element may be used to magnify the plurality of beams 110.

The holographic microscopy apparatus 100 may include a wavelength filter 117 disposed along a direction of the Poynting vector of the radiation 107 configured to filter out wavelengths of the radiation 107. In embodiments, the wavelength filter 117 may include one or more of a low-pass filter, high-pass filter, notch filter, bandpass filter, or another type of wavelength filter. The holographic microscopy apparatus 100 may further include a polarizer 118 disposed along a direction of the Poynting vector of the radiation 107 configured to filter out polarizations of the radiation 107. In embodiments, the polarizer 118 may include one or more polarizers configured to transmit, or filter out, horizontally polarized radiation, vertically polarized radiation, diagonally polarized radiation, circularly polarized radiation, elliptically polarized radiation, or a superposition of polarizations. The polarizer 118 may include a polarizer configured to transmit radiation having a polarization parallel to an active axis of the modulator 102. The wavelength filter 117 and the polarizer 118, may provide filtering and polarizing of the radiation to increase a signal-to-noise (SNR) ratio of the radiation 107, to further improve an SNR of the signal generated by the detector module 104. The apparatus 100 may further include mirrors 115 for directing the radiation 107 and the plurality of beams 110 throughout the apparatus 104 as required. Further, in embodiments, the holographic microscopy apparatus may include one or more spatial filters, amplitude modulators, phase modulators, mirrors, wavelength filters, beam splitters, diffractive elements, prisms, lenses, refractive elements, or other optical elements. In addition to modulating the radiation 107 to form the plurality of beams 110, the modulator 102 may additionally be configured to modulate the radiation 107 to correct for aberrations and distortions due to other optical elements of the apparatus 100. For example, the modulator 107 may provide phase corrections due to imperfections of lens surfaces, imperfections of mirror surfaces, index of refraction inconsistencies, debris, or another optical aberration. Additionally, the modulator 107 may be configured to provide a phase to the radiation 107 to correct for phase errors due to the modulator 102 itself.

The holographic microscopy apparatus 100 may be configured to be an addition to, or add-on to, another imaging system. For example, as illustrated in FIG. 1, the holographic microscopy apparatus 100 may be added onto an LLSM imaging system 150, with the LLSM imaging system 150 configured to provide the radiation to the holographic microscopy apparatus 100. The LLSM imaging system 150 includes a radiation source 152 that provides illumination radiation 153 to an illumination focusing element 154. The illumination focusing element 154 focuses the illumination radiation 153 onto a target 160, also referred to as a sample, to image the target 160. The radiation source 152 includes one or more galvanometric (galvo) mirrors to control a z-axis, or depth, focusing or probing of the target 160. A lattice structure 155, such as a crystal, is disposed to form a light sheet from the illumination radiation 153. The target 160 is disposed on a lattice stage 157. The target may reflect the radiation 153, or the illumination radiation 153 may be incident on fluorophores in the target 160. The illumination radiation 153 has a wavelength to cause the fluorophores to emit emitted radiation that is collected by an objective 162. The objective 162 magnifies the emitted radiation and directs the emitted radiation toward the holographic microscopy apparatus 100 as the radiation 107 provided to the holographic microscopy apparatus 100. In embodiments, additional, coupling optics may be employed to direct the radiation 107 from the objective 162 to the modulator 102 of the holographic microscopy apparatus 100, thereby optically coupling the imaging system 150 to the holographic microscopy apparatus 100. For example, as illustrated in FIG. 1, a mirror 164 may direct the radiation 107 from the objective 162 of the LLSM imaging system 150 to the holographic microscopy apparatus 100. Therefore, the LLSM system 150 may be a source of the radiation 107 for the holographic microscopy apparatus 100. In embodiments, an actuator may be physically coupled to the objective 163 to control a position of the objective 162. The actuator may be configured to alter a distance between the objective 163 and the target 160. In embodiments, the actuator may be a galvanometer, translation stage, piezoelectric device, or another actuator. Further, in embodiments, an actuator may be physically coupled to the lattice stage 157 to alter the position of the lattice stage 157.

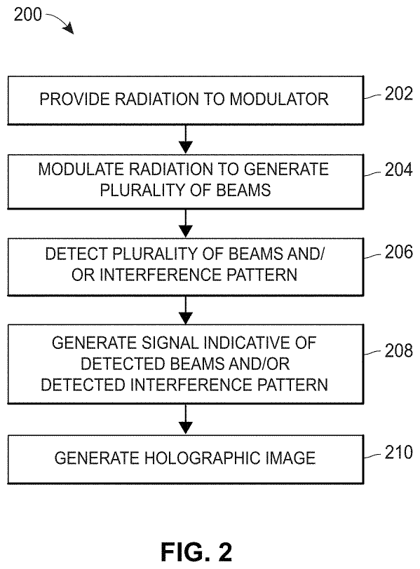

FIG. 2 is a flow diagram of a method 200 for performing IHLLS imaging as described herein. The method 200 of FIG. 2 may be performed by the holographic microscopy apparatus 100 of FIG. 1. Referring now simultaneously to FIGS. 1 and 2, the method 200 includes providing the radiation 107 to the modulator 102 (block 202). The modulator 102 is configured to modulate the radiation 107 according to modulation phase and amplitude profiles. The modulation phase and amplitude profiles are configured such that the modulator 102 modulates the radiation 107 to generate a plurality of beams 110 (block 204). In embodiments, the modulator 102 may include a spatial light modulator (SLM) configured to reflect and modulate the radiation 107 as the plurality of beams 110. In other embodiments, the modulator 102 may be a modulator that transmits the radiation 107 to form the plurality of beams 110.

The method 200 further includes detecting the plurality of beams 110 (block 206). The detector module 104 is configured to detect one or more of the plurality of beams, or to detect an interference pattern of two or more beams of the plurality of beams 110. The detector module 104 generates a signal indicative of the detected plurality of beams, and/or the detected interference pattern (block 208). The detector module 104 provides the signal to the processor 120 and the processor 120 generates a holographic image from the signal (block 210). The processor 120 may perform one or more machine executable instructions that cause the processor to perform one or more signal processing techniques, image processing techniques, optical analyses, transformations, or other processes for generating the holographic image. The generated holographic image may be presented to a user via a user interface, stored in a memory, provided to another storage device, provided to another system, and/or further processed.

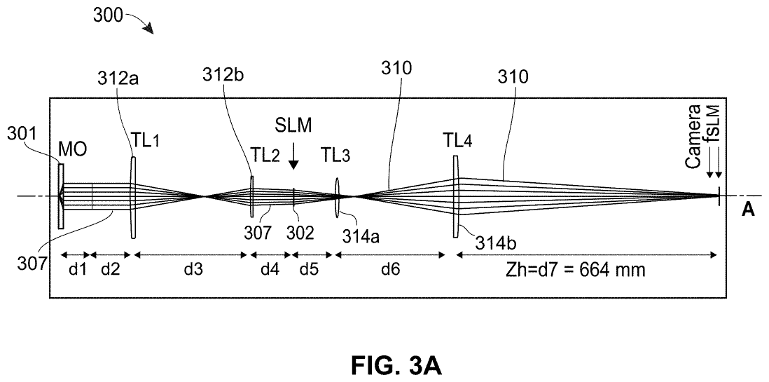

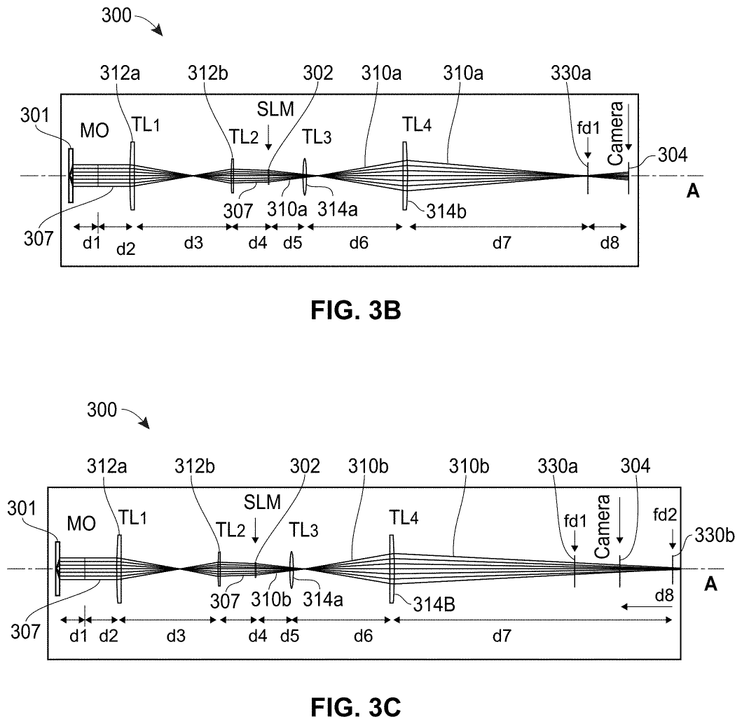

FIGS. 3A, 3B, and 3C are schematic diagrams of optical layouts for an IHLLS system 300. FIG. 3A is a schematic diagram of an IHLLS system having single diffractive lens configuration, while FIGS. 3B and 3C are schematic diagrams of an IHLLS system having two diffractive lenses. FIGS. 3A, 3B, and 3C include a source of radiation 301 providing radiation 307 along an optical axis A to a first lens 312a. In FIGS. 3A, 3B, and 3C, the radiation 307 has a Poynting vector with a direction parallel to the optical axis A. The first lens 312a focuses the radiation and a second lens 312b collimates the radiation. Together, the first and second lenses 312a and 312b perform as a telescope to magnify the radiation 307. A modulator 302 modulates the radiation 307 to generate a first beam 310a, illustrated in FIG. 3B, and a second beam 310b, illustrated in FIG. 3C, that co-propagate along the optical axis A. For the single diffractive lens configuration of FIG. 3A, the modulator 302 modulates the radiation 307 to form a single output beam 310. A third and fourth lens 314a and 314b perform together as a second telescope to further magnify and focus the first and second beams 310a and 310b. The first beam 310a is focused to a first focal plane 330a, and the second beam 310b is focused to a second focal plane 330b that is at a different location along the optical axis A than the first focal plane 330a. A detector 304 is disposed along the optical axis A to detect the first and second beams 310a and 310b, and any interference thereof.

To provide maximum interference of the first and second beams 310a and 310b at the detector 304, it may be desirable for the first and second beams 310a and 310b to have as much transverse overlap as possible at the detector 304. For example, as shown in FIGS. 3A and 3B, the modulator 302 may modulate the radiation 307 such that the transverse size of the first beam 310a and second beam 310b are equal at the detector. Although, the first focal plane 330a of the first beam 310a is along the optical axis A a distance before the detector 304, and the second focal plane 330b of the second beam 310b is along the optical axis A a distance behind the detector 304. Therefore, while the first and second beams 310a and 310b may have a maximum amount of transverse overlap at the detector 304, there may be a phase difference between the first beam 310a and second beam 310b at the detector 304. The modulator 302 may be configured to focus the first and second beams 310a and 310b anywhere along the optical axis, and further, may modulate the first and second beams 310a and 310b to provide a desired phase offset between the first and second beams 310a and 310b.

FIGS. 3A, 3B, and 3C include distance parameters between the optical elements of the IHLLS system 300. FIG. 3A illustrates the schematics of an IHLLS with only one diffractive lens, referred to as IHLLS 1L, and FIGS. 3B, and 3C illustrate the schematics of an IHLLS with two diffractive lenses, referred to as IHLLS 2L. Distance d₁ is the distance between the source of radiation 301 and a microscope objective MO. The distance d₂ is the distance between the microscope objective and the first lens 312a. The distance d₃ is the distance between the first lens 312a and the second lens 312b, distance d₄ is the distance between the second lens 312b and the modulator 302, distance d₅ is the distance between the modulator 302 and the third lens 314a, distance d₆ is the distance between the third lens 314a and the fourth lens 314b, distance d₇ is the distance between the fourth lens 314b and the either the first focal plane 330a or the second focal plane 330b as illustrated by FIGS. 3B and 3C respectively, and distance d₈ is the distance between the detector 304 and the first and second focal planes 330a and 330b as illustrated in FIGS. 3B and 3C respectively.

To generate a holographic image as described in the IHLLS method and system described herein, a hologram must be obtained from the interference pattern of multiple beams at the detector 304. For example, using the illustrations of FIGS. 3B and 3C, the radiation 307 may be one or more Bessel beams having positive spherical wavefronts. As such, the interference between the first and second beams 310a and 310b, which are focused to the first and second focal planes 330a and 330b, may be determined by the expression

$$U = [ {C}_{1} Q ( - \frac{1}{{fd}_{1}} ) + {C}_{2} exp ( i θ ) Q ( - \frac{1}{{fd}_{2}} ) ] , \qquad EQ . 1$$

where Q is the quadratic phase function

Q(b)=exp[(iπλ⁻¹(x²+y²)], EQ. 2

θ is the phase shift of the SLM, f_{d1} is the focal length of a first diffractive lens, and f_{d2} is the focal length of a second diffractive lens. The first and second diffractive lenses are superimposed on the modulator 302, and the first lens generates the first beam 310a and having a focus at the first focal plane 330a, and the second lens and C₁=C₂=0.5 are constants. Therefore, employing the optical system and method of FIGS. 1 and 2, with EQS. 1 and 2, the interference of a plurality of beams at a detector may be determined, and a holographic image may be generated. It should be noted, that by setting either one of the superimposed lens focal lengths to infinity, either f_{d1}=∞ or f_{d2}=∞, EQ. 1 reduces to a single lens term weighted by either C₁ or C₂, effectively creating a single lens superimposed on the SLM. The single lens superimposed SLM will be described further herein in reference to single lens IHLLS imaging measurements.

To demonstrate the described IHLLS, a holographic apparatus according to the apparatus 100 of FIG. 1 was constructed. Similar to the illustration of FIG. 1, an LLS system, such as the LLS system 150 of FIG. 1, provided the radiation 107 to the constructed apparatus. For clarity, references to FIGS. 1, 3A, 3B, and 3C will be used for the following examples of performing IHLLS imaging.

To demonstrate IHLLS imaging, an SLM was employed as the modulator 102 and the radiation 107 had a wavelength of 520 nm. The SLM was a phase SLM (Meadowlark; 1920×1152 pixels), that was recalibrated to phase shift the radiation 107 to form two beams as the plurality of beams 110. The SLM was configured to apply a full range of 0 to 27 phase shift over its working range of 256 gray levels.

The detector module 104 was a CMOS ORCA camera and various components of the apparatus 100 and the LLS 150 were controlled by a Labview platform (National Instruments). A custom diffraction method was developed using MATLAB (Mathworks, Inc.), and the complex hologram was propagated and reconstructed at a focal plane using the custom diffraction method.

Performance of the holographic microscopy apparatus 100 was compared to conventional LLS imaging by superimposing two different lens configurations onto the active surface of the SLM, (i) a single lens was superimposed on the SLM was to generate one beam from the radiation 107, and (ii) two diffractive lenses were superimposed on the SLM to generate two beams as the plurality of beams 110. The single lens configuration is referred to herein as IHLLS 1L, and the two diffractive lens configuration is referred to herein as IHLLS 2L.

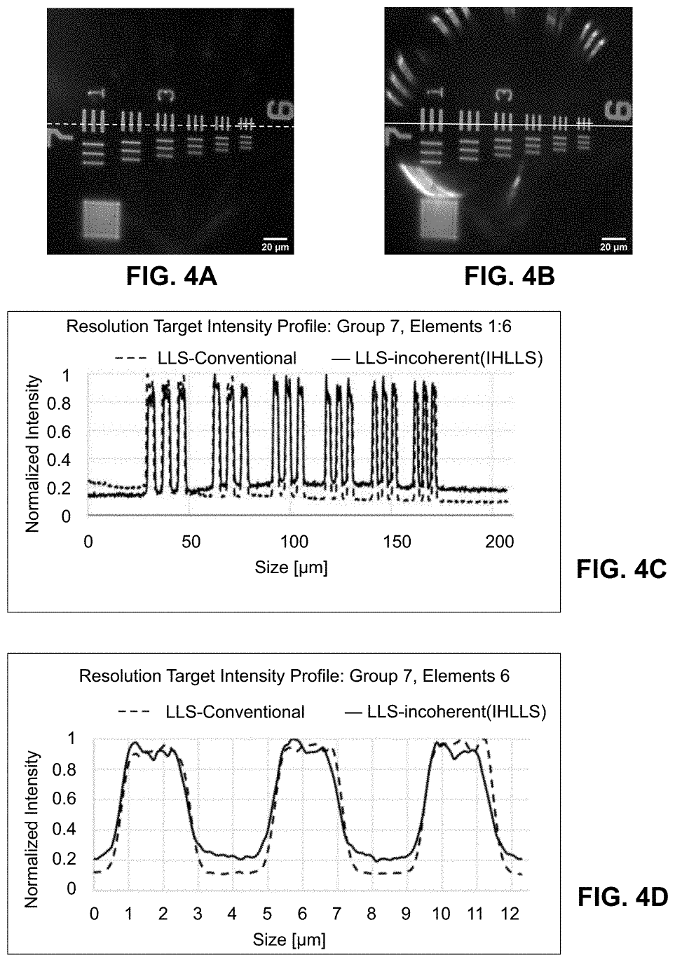

Optical simulations of IHLLS were performed in two steps. First, the distances between each sequential optical component and the focal length of f_{SLM} of a diffractive lens superimposed on the SLM, were calculated to match the transversal pixel magnification of 62.5 for both conventional LLS and IHLLS 1L (FIG. 3A) configurations, using OpticsStudio (Zemax, LLC) optical design. It was determined that with the radiation 307 having an emission wavelength of 520 nm, and with an overall transversal magnification set to 62.5, the distances should be about, d₁=75 mm, d₂=95.074 mm, d₃=288.914 mm, d₄=103.660 mm, d₅=103.660 mm, d₆=288.914 mm, the distance between the fourth lens 314b to the detector 304 should be about 664 mm (i.e., d₇=664 mm), and the focal length of the single diffractive lens superimposed on the SLM was determined to be f_{SLM}=400 mm. For the first step, the transversal magnification was checked by imaging a USAF 1951 resolution target, group 7, element 6, with both conventional LLS and the IHLLS 1L setup using a white light source. FIG. 4A is a y-x LLS image of the resolution target, and FIG. 4B is an x-y IHLLS 1L image of the resolution target. As evidenced by comparing the cross-sections, along the dashed lines, of group 7 of FIG. 4C, and element 6 of FIG. 4D, the IHLLS 1L provides the same magnification of 62.5 as the conventional LLS system. Additionally, an optimization of a multi-configuration optical system, as shown in FIGS. 3B and 3C, was performed to calculate the focal lengths of two diffractive lenses superimposed on a spatial light modulator to provide maximum overlap of the two beams at the plane of the detector 304 and keeping all of the distances d₁÷d₇ fixed as determined in the above for the previous step. After performing the optimization, the values of the two focal lengths were found to be f_{d1}=220 mm and f_{d2}=2356 mm., which were used for the design of two diffractive lenses. The two lenses focus at a distance d₇=555.185 mm in the front of the camera, FIG. 3B, and at d₇=826.793 mm behind the camera, FIG. 3C, respectively. In implementation, the distance d₇+d₈ may need to be tuned by ±0.3 depending on tolerances and imperfections of optical parameters of other elements of the system (e.g., tolerances of lenses, tolerances of phase resolution of the SLM, etc.). (i.e., d_{7_1}+d₈=664.298 mm, when calculating f_{d1}, and d₇+d₈=663.793 mm, when calculating f_{d2}. FIGS. 4C and 4D are plots of the normalized image intensity cross-sections for the group 7, and element 6 respectively, of the resolution target according to the images of FIGS. 4A and 4B. In both of the plots of FIGS. 4C and 4D there is a complete overlap of the intensities, which means a complete matching of the transversal magnification of the two modules, the LLS detection path and the IHLLS 1L detection path.

As previously discussed, to achieve high diffraction efficiency, and therefore high a contrast interference pattern at the detector 304, the first and second beams 310a and 310b formed by the SLM must overlap at a detection plane of the detector module 310. To determine the various distances between, and optical parameters of, the elements of the ILSSM system 300, the OpticsSetup optical design software was used. Keeping all the distances d₁ to d₇ constant, and superimposing two diffractive lenses onto the SLM, a multi-configuration optical system was determined having the transverse height of the two beams equal in size at the camera plane (e.g., at the detector 304). It was determined that, to provide a maximal overlap of the two beams at the detector 304, the first focal plane 330a should be at a focal distance of f_{d1}=220 mm from the SLM, and the second focal plane 330b should be at a focal distance of f_{d2}=2356 mm from the SLM. As previously mentioned, the various distances of the first and second focal planes 330a and 330b are approximate values, and in practice, they may be tuned by ±0.5 to ±5 mm, or more, depending on tolerances and imperfections of optical parameters of other elements of the system.

An IHLLS 2L imaging system was built according to the setups of FIGS. 1, 3B, and 3C using the optical element distances and focal distances determined by the simulations, and by superimposing two lenses on the SLM. The constructed IHLLS imaging system was used to image fluorescent latex beads that fluoresce at 500 nm and 200 nm (λ_{esc}=488 nm, λₑₘ=520 nm, L-5222, Molecular Probes, USA). The beads were placed in a solution having a concentration of 2% of the solid beads, and the solution was diluted to a ratio of 1:4000 with distilled water. The solution was centrifuged in a desktop centrifuge for 1 minute and clean coverslips were prepared by applying 1 μL of the solution as a thin layer that was left to dry. After drying, a cover slip was mounted in a sample holder of a conventional LLS system under distilled water. Three tests were performed to evaluate the performance of the IHLLS 2L imaging system. The first test was used a conventional LLS pathway having a z-galvonometer control the position of a microscope objective to collect images of multiple z-planes of the 500 nm fluorescent beads. The z-galvonometer was stepped in increments of δz_{LLS}=0.2 μm through the focal plane of a 25× Nikon objective which was simultaneously moved the same distance with a z-piezo controller for a displacement range of Δz_{galvo}=60 μm. The transverse scanning area of each image was 104×104 μm² for the conventional LLS system. A second set of images of the 500 nm fluorescent beads was obtained using the IHLLS 1L with an SLM superimposed lens focal length of f_{SLM}=400 mm. Both the z-galvonometer and z-piezo were stepped by the same increment of δz_{LLS}=0.2 μm through the focal plane of the objective for the same displacement Δz_{galvo}=60 μm as in the conventional LLS measurements. The two measurements described above, using the conventional LLS and IHLLS 1L imaging systems, were repeated to image the 200 nm fluorescent beads.

The two measurements described above, using the conventional LLS and IHLLS 1L imaging systems, were repeated to image the 200 nm fluorescent beads. For both the conventional LLS and the IHLLS 1L systems, the 200 nm beads were imaged with a transverse scanning area of 208×208 μm², a galvanometer displacement of Δz_{galvo}=80 μm, by increments of δz_{LLS}=0.16 μm. For conventional LLS, the scanning area is typically limited to about 54×54 μm², with some operating up to 78×78 μm². Therefore, multiple 54×54 μm² images were obtained in a mosaic-fashion by moving the sample, to form a single image at a given z-galvonometer position. This multiple image mosaicing requires substantially longer acquisition time and images registration for an LLS system than the disclosed IHLLS 1L, and the IHLLS 2L, systems.

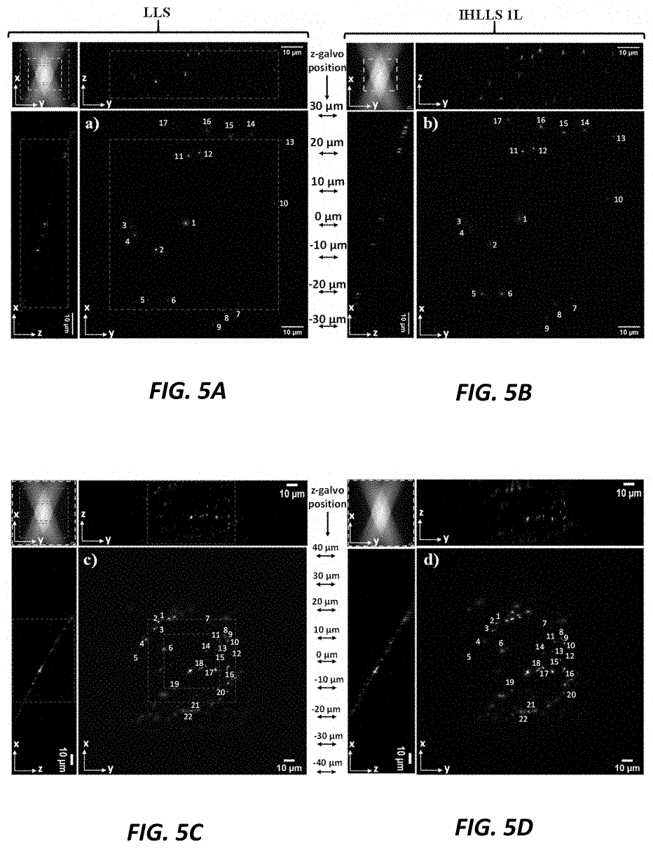

FIGS. 5A and 5B are tomographic images of the 500 nm fluorescent beads obtained by the conventional LLS system and the IHLLS 1L system, respectively. The images of FIGS. 5A and 5B were obtained using 300 steps of the z-galvonometer and have transverse scanning areas of 104×104 μm². FIGS. 5C and 5D are tomographic images of the 200 nm fluorescent beads obtained by the conventional LLS system and the IHLLS 1L system respectively. The images of FIGS. 5C and 5D were obtained using 500 steps of the z-galvonometer and have transverse scanning areas of 208×208 μm². The Bessel beam profiles used to obtain each of the images of FIGS. 5A though 5D are displayed in the upper left corners of FIGS. 5A through 5D respectively.

In the measurements of the fluorescent beads, the IHLLS 1L system has an increased transverse scanning area and shorter imaging times than conventional LLS. One reason for these improvements is the larger potential scanning area of the IHLLS 1L system as compared to the conventional LLS system. It was also determined from FIGS. 5A through 5D that the IHLLS 1L system exhibited a decrease in image resolution, in both lateral and axial directions, due to a blurring effect of the SLM due to the superimposed lens that has a focal distance of infinity, as previously described.

The IHLLS 2L system was also used to image the 500 nm and 200 nm fluorescent beads. The measurements performed by the IHLLS 2L system also translated the z-gavlonometer according to the total galvanometer translation, and displacement intervals as was used for the conventional LLS and IHLLS 1L measurements. The two beam wavefronts interfered at the detector 304 and created Fresnel holograms captured by the detector 304. The modulator 302 was configured to provide multiple sets of beams with each set having two beams with a different phase offset. Each set of two beams was generated by the modulator 302 at a different time than other sets of beams to generate a time-series of four different sets of beam pairs. Each set of beam pairs had a phase offset of either 0°, 90°, 180°, or 270° (i.e., phases of 0, π/2, π, and 3π2). An image was captured at each of the four phase offsets at each position of the z-galvonometer. Therefore, each image plane in the z direction of the image target included four images, with each image capturing the interference pattern generated by a corresponding phase offset of the generated beams. The four images, for a given galvanometer position, were used to determine a complex amplitude of the wavefronts at the detector 304 according to the equation

U(u,v)=A(u,v)exp(iϕ(u,v))=¼{(I_{H(u,v,0)}−I_{H(u,v,π)}+i(I_{H(u,v,π/2)}−I_{H(u,v,3π/2)}} EQ. 3

where A(u, v) is an amplitude profile of the image, each term I_{H} is an hologram image intensity for one of the four phase images, and ϕ(u, v) is the phase profile of the image according to

$$∅ ( u , v ) = arc tan [ \frac{{I}_{H} ( u , v , 0 ) - {I}_{H} ( u , v , π )}{{I}_{H} ( u , v , π / 2 ) - {I}_{H} ( u , v , 3 π / 2 )} ] . \qquad EQ . 4$$

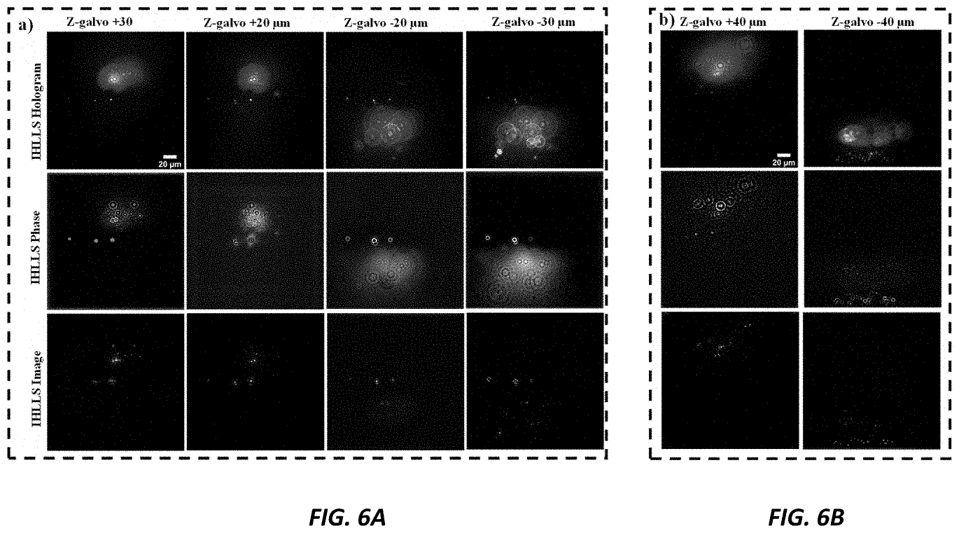

FIGS. 6A and 6B are arrays of holographic images obtained by the IHLLS 2L system of the 500 nm and 200 nm fluorescent beads, respectively. Each column of the image arrays of FIGS. 6A and 6B includes a set of images obtained at a given z-galvonometer position. A z-galvonometer position of z_{galvo}=30 μm provides an image of a top layer of beads, while a position of z_{galvo}=−30 μm provides images of a bottom layer of beads, and positions of ±20 μm, ±10 μm, and 0 μm, provide images of beads that are equidistant between the top and bottom layers. Images of other z-galvonometer positions were obtained and are not presented in FIGS. 6A and 6B. The rows of images include a top row of IHLLS holograms detected at the camera or detector 304, a middle row of IHLLS phase images of ∅ as determined by EQ. 4, and a bottom row of IHLLS reconstructed images of the complex amplitude of EQ. 3. The phase images of the middle row contain depth dependent phase information derived from the IHLLS holograms of the top row of images. The complex holograms were propagated and reconstructed at a desired focal plane for increasing resolution and contrast using a custom diffraction Angular Spectrum method (ASM) routine in MATLAB (Mathworks, Inc.) to generate the bottom row of IHLLS reconstructed images. The ASM was implemented instead of a Fresnel reconstruction since the ASM can reconstruct a wave field at any distance from the hologram plane with no restriction on the propagation distance. In embodiments, the reference plane for depth scanning is taken as the plane where the position of the z-galvanometric mirror coincides with the z-piezo stage objective position, which is the middle plane of the camera FOV. The sample is in focus at this position, referred to as ‘Z-galvo 0 μm’. In embodiments, other reconstruction method schemes may be implemented as a combination of ASM and Fresnel methods. The ASM may be implemented for the in-focus samples and the Fresnel implemented for reconstruction of the out-of-focus samples.

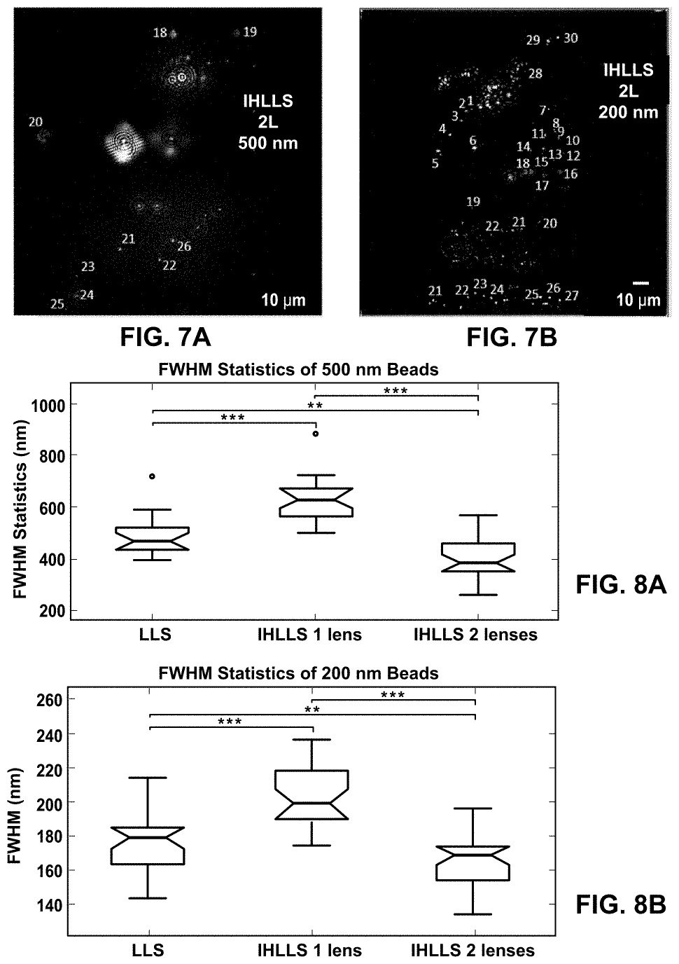

FIGS. 7A and 7B are images of the maximum composite projections of all of the reconstructed complex amplitudes at the z-galvonometer mirror positions z-galvo of 0 μm, ±10 μm, ±20 μm, and ±30 μm for the 500 nm and 200 nm fluorescent beads, respectively, with high resolution and contrast. The images of FIG. 7B include an extended scanning range of ±40 μm.

FIGS. 8A and 8B present the transverse full-width at half-maximum (FWHM) values for images obtained by the conventional LLS, IHLLS 1L, and IHLLS 2L systems for the 500 nm beads and the 200 mm beads, respectively. A custom peak-finding routine was used to identify the locations for each bead. The peak-finding routine defined a region of interest (ROI) around each potential bead in each tomographic and holographic reconstructed image (i.e., the images of FIGS. 4a-4D, &a, and 7B). A least square fit to a 2D Gaussian function was performed in each region of interest and the center-of-mass position and FWHM in x and y for each ROI was determined. For the images of the 200 nm beads, conventional LLS had a FWHM of 178 nm, IHLLS 1L had a FWHM value of 203 nm, and the IHLLS 2L system had a FWHM value of 165 nm. The calculations for the 500 nm beads show an LLS FWHM of 486 nm, IHLLS 1L FWHM of 631 nm, and a IHLLS 2L FWHM of 395 nm. The FWHM values of the IHLLS 1L and IHLLS 2L systems are a factor of 1.03 to 1.2 times smaller than in LLS. With a * p-value≤0.05, ** p-value≤0.01, and *** p-value≤0.001, where p-value≤0.05 is a statistically significant difference and p-value>0.05 is not statistically significant difference.

The disclosed system and method for performing IHLLS may be useful for imaging of sensitive materials such as biological samples and tissues. For example, imaging of neuronal cells may provide the foundation for understanding many diseases in the human brain. Understanding and analyzing the physiological behavior of the neuronal cells requires the ability to observe cell structure and dynamics quantitatively to cellular and subcellular levels. The described IHLLS imaging system and method provides a noninvasive contrast imaging technique that uses low intensity radiation, which preserves the integrity of the cell. Further, neuronal cells are 3D structures that extend throughout tissue in all directions and many conventional microscopy methods are unable to resolve the cellular structures into 3D images. Conventional approaches are unable to image in the millisecond temporal range at multiple depths simultaneously. The disclosed IHLLS system allows for the 3D holographic imaging of neurons and other cells at imaging speeds capable of capturing physiological responses and cellular dynamics.

As an example, neuronal cells could respond electrically to chemical and electrical inputs. The electrical response could rapidly spread throughout the neuronal cell structure. The electrical response rapidly spreads throughout the neuronal cell structure. The electrical activity in the neuronal cell causes a change in the refractive index of the cell, which, can be imaged over time by the disclosed IHLLS imaging techniques. To demonstrate the observation of cellular behavior, an IHLLS system was constructed to image biological samples.

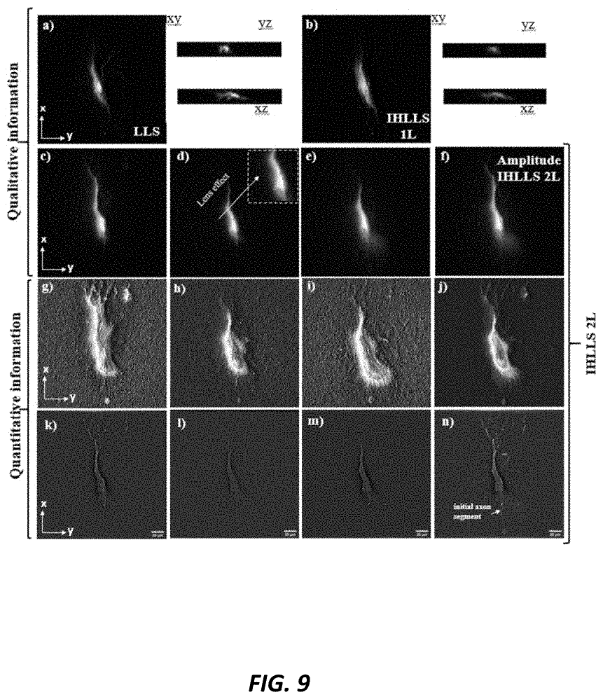

Quantitative phase cell imaging was performed using an IHLLS 2L system according to the description of the IHLLS 2L system above. The target to be imaged was a lamprey spinal cord ventral horn neuron with dendrites that were sufficiently large to cover the whole detector FOV of 208×208 μm². Images of the target neuron were obtained using the conventional LLS system, the IHLLS 1L system, and the IHLLS 2L system. FIG. 9 is an array of images of the target neuronal cell obtained by each of the conventional LLS, IHLLS 1L, and IHLLS 2L systems.

FIGS. 9a and 9b are tomographic images obtained by using conventional LLS and IHLLS 1L, respectively. The conventional LLS system had maximum transverse imaging area of 78×78 μm², and therefore, features of the target cannot be resolved outside of that area. Each of the images of FIGS. 9a and 9b was obtained using a z-galvonometer and z-piezo stage objective that were positioned across a range of 60 μm over 300 steps. Deconvolution sharpening of the raw data was performed to reduce blur and enhance fine details of the images of FIGS. 9a and 9b. FIGS. 9c-9f are images obtained by the IHLLS 2L system for the max projection of three reconstructed amplitude images from IHLLS holograms recorded at z_{galvo}=30 μm, 0 μm, and −30 μm. The reconstructed holographic images of FIGS. 9c-9f provide similar image quality as the LLS image of FIG. 9a, with the IHLLS 2L images resolving a larger imaging area of the target or sample (i.e., the neuronal cell). FIGS. 9g-9j provide quantitative phase information that is unable to be obtained by the conventional LLS system. The phase images of FIGS. 9g-9j are important for understanding the physiology and pathophysiology of various cells, tissues, and other types of biological samples. FIGS. 9k-9n are images of the phase information after a bandpass filter has been applied to the phase information. The bandpass filter applied in FIGS. 9k-9n allows for the attenuation of certain spatial frequencies in the images to accentuate specific features of the cell to be observed and further studied.

In implementations, multiple wavelengths of radiation may be used for performing IHLLS, referred to herein as multi-wavelength IHLLS, or ICHLLS. Imaging of a sample using multiple wavelengths of light allows for multiple types of tissues, fluorophores, or proteins to be probed and observed simultaneously, or nearly simultaneously. For example, one wavelength of radiation may be used to probe the pH level of a sample, while another wavelength of radiation is used to image calcium to determine changes in calcium levels to correlate the pH level of the sample with calcium levels. Additionally, for biological samples, imaging samples with multiple wavelengths of radiation allows for imaging of physical structures with one wavelength while simultaneously imaging and probing one or more biological processes. Therefore, physical structural changes can be monitored and correlated with chemical and biological processes occurring in the sample.

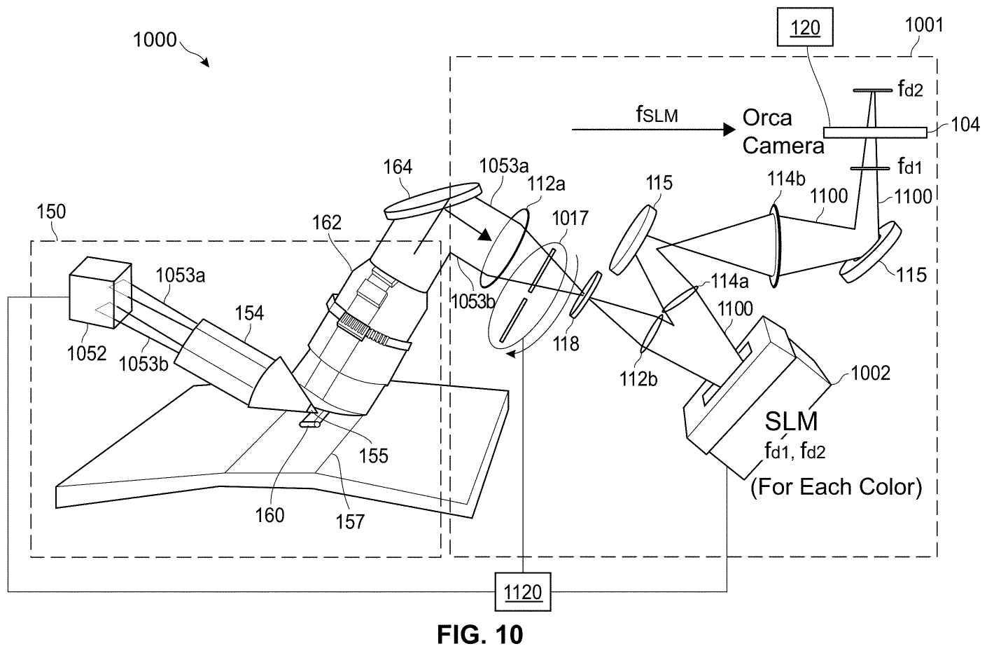

FIG. 10 is a schematic diagram of an embodiment of a multi-wavelength holographic microscopy detection apparatus 1000 for performing multi-wavelength IHLLS, called Incoherent Color Lattice Lattice-Light Sheet (ICHLLS) as described herein. The multi-wavelength holographic microscopy apparatus 1000 includes a spatial light modulator (SLM) 1002 and a detector module 104. A source of radiation, or radiation source 1052, provides a first radiation 1053a having a first wavelength, and second radiation 1053b having a second wavelength different from the first wavelength. For clarity and simplicity, the radiation source 1052 is described herein as providing two different wavelengths of radiation, but it should be understood that the radiation source 1052 may provide more than two wavelengths of radiation. For example, the radiation source 1052 may be a tunable laser, or broadband LED that is capable of providing radiation over a broad range of wavelengths. Further, the radiation source 1052 may include a plurality of lasers or light sources having different emission spectra. The radiation source 1052 may be configured to provide interlaced pulses of the first and second radiation 1053a and 1053b to provide the two different wavelengths of radiation to a target 160, as referred to as a sample. Each of the first and second radiation 1053a and 1053b may be visible radiation, near-infrared radiation, infrared radiation, ultraviolet radiation, or another type of radiation for performing imaging.

As previously described with reference to FIG. 1, the radiation source 1052 may be part of an LLSM imaging system 150. The LLSM imaging system 150 includes an illumination focusing element 154 that focuses the first and second radiation 1053a and 1053b onto the target 160 to image the target 160. The target 160 is disposed on a lattice stage 157. The lattice element 157 forms a light sheet from the first and second radiation 1053a and 1053b. The first and second radiation 1053a and 1053b cause fluorophores of the target 160 to fluoresce and release emitted radiation, and the objective 162 is physically configured to collect the emitted radiation. The objective 162 magnifies the emitted radiation and directs the emitted radiation toward the holographic microscopy apparatus 1001. As described with reference to FIG. 1, one or more actuators may be physically coupled to the objective 162 and/or the stage 157 to changing a distance between the objective 162 and the stage 157. In embodiments, additional, coupling optics may be employed to direct the first and second radiation 1053a and 1053b from the objective 162 to the SLM 1002 of the holographic microscopy apparatus 1001, thereby optically coupling the imaging system 150 to the holographic microscopy apparatus 1001. For example, a mirror 164 may direct the radiation 107 from the objective 162 of the LLSM imaging system 150 to the holographic microscopy apparatus 100. The first and second lenses 112a and 112b operate together as a telescope to magnify, or demagnify, the first and second radiation 1053a and 1053b onto the SLM 1002. It may be desirable to increase or decrease a beam size of the first and second radiation 1053a and 1053b according to the size of the SLM 10002 and other optics.

A multi-wavelength bandpass filter (BPF) 1017 is disposed along a direction of the Poynting vector of the first and second radiation 1053a and 1053b configured to filter out undesirable wavelengths of the first and/or second radiation 1053a and 1053b. The multi-wavelength BPF 1017 may be a single BPF element having multiple transmission peaks, the multi-wavelength BPF 1017 may include multiple BPF elements that are switched into, and out of, the propagation path of the first and second radiation 1053a and 1053b. For example, the multi-wavelength BPF 1017 may include multiple BPFs disposed around a rotary wheel with the rotary wheel positioning a BPF in the propagation path of the first and/or second radiation 1053a and 1053b. The multi-wavelength BPF 1017 transmits center wavelengths of light corresponding to the presence of the first or second radiation 1053a and 1053b. For example, in the embodiment where the multi-wavelength BPF 1017 is a rotary wheel with multiple BPFs, the multi-wavelength BPF 1017 may have a rotation speed corresponding to a pulse width and pulse train timing of pulses of first and second radiation 1053a and 1053b provided by the radiation source 1052. As such, the multi-wavelength BPF 1017 is synchronized to the output of the radiation source 1052 to transmit first or second wavelengths of radiation corresponding to the first and second radiations 1053a and 1053b.

The multi-wavelength BPF 1017 may include more than two BPFs, or have more than two transmission peaks, corresponding to the number of excitation radiation center wavelengths provided by the radiation source 1052. In any embodiment, the multi-wavelength BPF 1017 has bandpass widths wide enough to transmit enough radiation to image the sample 106, and bandpass widths narrow enough to preserve the coherence of the first and second radiation 1053a and 1053b. Automation of the multi-wavelength BPF 1017 and synchronizing the multi-wavelength BPF 1017 transmission with the radiation source 1052 allows for the system to provide images of the sample 106 at various wavelengths of radiation without having to retune the system or change any elements of the system manually. The multi-wavelength BPF 1017 further enables the real time synchronous imaging and probing of multiple physical, biological, or chemical structures and processes using multiple wavelengths of radiation.

The polarizer 118 is configured to filter out polarizations of the first and second radiation 1053a and 1053b to further preserve the coherence of the radiation. The wavelength filter 117 and the polarizer 118, may provide filtering and polarizing of the radiation to increase a SNR ratio of the first and/or second radiation 1053a and 1053b.

The SLM 1002 is configured to superimpose a plurality of lenses on an active area of the modulator. Each lens of the plurality of lenses has a focal length dependent on a corresponding wavelength of radiation, to generate a plurality of beams and to focus each of the wavelengths of radiation to a same focal distance for imaging. For example, the SLM 1002 modulates the first radiation 1053a or second radiation 1053b to generate a plurality of beams 1100 from the respective first or second radiation 1053a and 1053b. The plurality of beams 1100 of the first and second radiation 1053a and 1053b is illustrated in FIG. 10 as a single beam for visual. The plurality of beams 1100 includes at least two beams that are at least partially spatiotemporally overlapped to generate an interference pattern between the overlapped beams. To generate the plurality of beams, the SLM 1002 generates two diffractive lenses superimposed on the SLM 1002. Two diffractive lenses are designed and superimposed on the SLM 1002 to focus the first radiation 1053a onto the detector module 104, and two different diffractive lenses are designed and superimposed on the SLM 1002 to focus the second radiation 1053b onto the detector module 104. Similar to the multi-wavelength BPF 1017, the SLM 1002 may be synchronized with pulses of the first and second radiation 1053a and 1053b, or synchronized with the radiation source 1052 to superimpose a specific set of diffractive lenses according to the wavelength of radiation provided to the SLM 1002 at a given time. Therefore, superimposing the various sets of lenses onto the SLM further enables automatic switching of imaging using one wavelength of radiation, to imaging using a different wavelength of radiation without having to manually change elements or components of the apparatus 1000. In addition to modulating the first and second radiation 1053a and 1053b to form the plurality of beams 1100, the SLM 1002 may additionally be configured to modulate the first and second radiation 1053a and 1053b to correct for aberrations and distortions due to other optical elements of the multi-wavelength holography apparatus 1000.

The third lens 114a and fourth lens 114b are configured to operate together as a telescope to magnify the plurality of beams 1100. In embodiments, it may be desirable to increase or decrease the size of one or more beams of the plurality of beams 1100 according to the size of a detection area of the detector module 104, and/or the size of the active area of the SLM 1002. The detector module 104 may include one or more sensors that have defined detection areas for detecting one or more of the beams of the plurality of beams 1100 at the wavelengths of the first and second radiation 1053a and 1053b, and/or for detecting interference between beams of the plurality of beams 1100. Mirrors 115 may be implemented to guide the first radiation 1053a, second radiation 1053b, and plurality of beams 1100 between various elements of the apparatus 1000.

The detector 104 is disposed along a propagation direction of the plurality of beams 1100 (e.g., along one or more Poynting vectors of a beam of the plurality of beams), with the detector 104 configured to detect the interference pattern of the overlapped beams. The detector 104 may include one or more of a CMOS detector, a charge-coupled device (CCD), one or more photodiodes or photodiode arrays, a photovoltaic detector, a photomultiplier tube, a metal-oxide-semiconductor (MOS) capacitor, or an infrared sensor capable of detecting wavelengths of the first and second radiation 1053a and 1053b. The detector 104 is configured to generate a signal indicative of the detected interference pattern, and to provide the generated signal to the processor 120 for performing hologram generation, hologram reconstruction in amplitude and phase, and image processing. Further, the processor 120 may be configured to perform any required processing, calculations, or functions described herein to generate a holographic image. The processor 120 may generate independent image frames corresponding to independent pulses of radiation provided by the radiation source 1052 for imaging the sample 106. For example, the processor 120 may generate a first image frame corresponding to an image of the sample taken by detecting the first radiation 1053a, and the processor 120 may generate a second image from probing the sample 106 with the second radiation 1053b. The processor 120 may generate a plurality of image frames corresponding to pulses in a radiation pulse train provided by the radiation source 1052. The apparatus 1000 may generate images at rates of hundreds or thousands of frames per second depending on the exposure amounts required to collect adequate radiation for generating images. The apparatus 100 may perform imaging with exposure times on the order of 100 ms, or tens of milliseconds, and it is envisioned that shorter exposure times may be achievable using more sensitive camera technologies. As such, biological and chemical processes that occur at time scales on the order of milliseconds and tens of milliseconds may be resolved.

As described herein, the multi-wavelength BPF 1017 and the SLM 1002 may be synchronized to the radiation source 1052 to perform functions for automated multi-wavelength IHLLS. In embodiments, a controller 1120 may be in communication with the radiation source 1052 to control the radiation source 1052. For example, the controller 1120 may control a radiation source 1052 to cause the radiation source 1052 to provide radiation having a specified wavelength, at pulses having a specific pulse width. The controller 1052 may cause the radiation source to provide radiation in pulse trains with pulses having different radiation wavelengths. The controller 1120 may control the multi-wavelength BPF 1017 to transmit radiation according to the pulse train, or wavelength of radiation provided by the radiation source 1052. Additionally, the controller 1120 may control the SLM 1002 to superimpose one or more diffractive lenses for generating the plurality of beams 1100 depending on the pulse train timing and wavelength of radiation provided by the radiation source 1052.

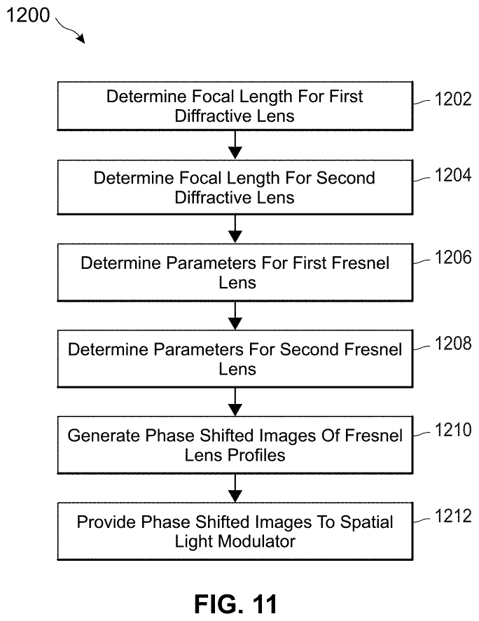

FIG. 11 is a flow diagram of a method 1200 for generating diffractive lenses for superimposing onto the SLM 1002. The method 1200 will be described with reference to FIG. 10. The method 1200 includes determining a first focal length of a first diffractive lens to focus the first radiation 1053a at the detector 104 (block 1202), the first focal length being dependent on the wavelength of the first radiation 1053a. A second focal length is then determined to focus the second radiation 1053b onto the detector 104. The second focal length being for a diffractive lens superimposable on the SLM 1002. The processor 120 may determine the first and second focal lengths. The focal lengths of the first and second superimposed diffractive are shown in FIG. 10 at f_{SLM}.

The method 1200 includes determining amplitude and phase modulation profiles of a first superimposable Fresnel lens from the first focal length (block 1206) and determining phase and amplitude parameters of a second superimposable Fresnel lens from the second focal length (block 1208). To determine the optical phase and amplitude modulations of the first and second Fresnel lenses, the processor 120 may run a script or code such as Matlab or Python script. The method 1200 further includes generating a plurality of phase shifted lens profiles for the first and second Fresnel lenses (block 1210). The phase shifted profiles are then provided to the SLM 1002 to superimpose either the first or second diffractive Fresnel lens onto the SLM 1002 (block 1212) as described previously for IHLLS, and in EQs. 1-4.

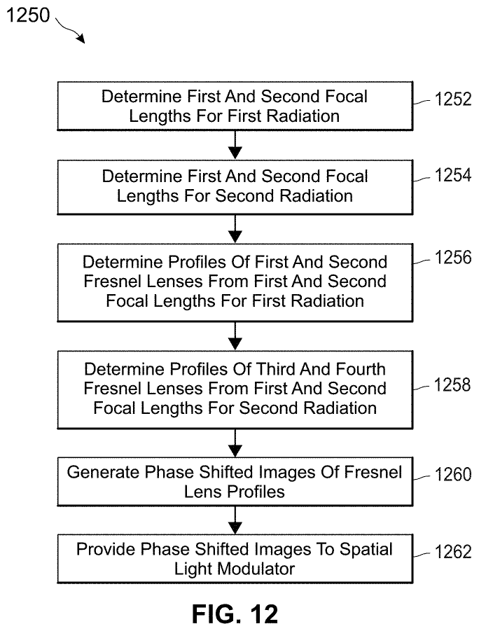

FIG. 12 is a flow diagram of a method 1250 for generating dual superimposed diffractive lenses for performing multi-wavelength holography as described herein. The method 1250 includes determining a first focal length, f_{d1}, and a second focal length, f_{d2}, for first radiation having a first wavelength (block 1252). The first focal length being a focal distance that focuses the first radiation before the detector 104, and the second focal length focusing the radiation at a distance longer than the distance from the SLM 1002 to the detector 104 along the path of propagation of radiation. First and second focal lengths are then determined for the second radiation (block 1254), with the first and second focal lengths dependent on the wavelength of the second radiation.

The method 1250 further includes determining first and second superimposable diffractive Fresnel lens profiles respectively having the first and second focal lengths for the first radiation (block 1256). The first and second Fresnel lens profiles having amplitude and phase profiles that focus the first radiation at the first and second focal lengths respectively. Third and fourth diffractive Fresnel lens profiles respectively having the first and second focal lengths for the second radiation (block 1258). The third and fourth Fresnel lens profiles having amplitude and phase profiles that focus the second radiation at the first and second focal lengths respectively. It should be understood that the third and fourth Fresnel lens profiles have different focal lengths than the first and second Fresnel lens profiles due to the difference in wavelengths of the first and second radiation. The method 1200 further includes generating a plurality of phase shifted lens profiles for the first, second, third, and fourth Fresnel lenses (block 1260). The phase shifted profiles are then provided to the SLM 1002 to superimpose one of the first, second, third, or fourth diffractive Fresnel lens onto the SLM 1002 (block 1262).

A multi-wavelength IHLLS system, also referred to as an ICHLLS system, was built according to FIG. 10 and imaging of spinal neurons was performed. The radiation source 1052 was configured to provide radiation at 488 nm and 561 nm. Neuronal cells were used as the target 160 and fluorophores were provided to the target 160. The 488 nm radiation caused one fluorophore type to fluoresce around 520 nm, and the 561 nm radiation caused a second type of fluorophore to fluoresce around 575 nm. The multi-wavelength BPF 1017 employed a BPF at 520 nm with a 40 nm bandpass range, and a BPF at 575 nm with a bandpass range of 26 nm. The radiation source 1052 may include one or more galvo-mirrors to change a scanning depth of the ICHLLS imaging system. The total available scanning depth is dependent on two variables, the numerical aperture of an LLS diffraction mask annulus and the z-galvanometer mirror scanning range. Using an annulus of 0.55 outer NA and 0.48 inner NA, the scanning depth into a sample could reach up to 80 μm, using 9 z-galvo positions within the range Δz_{galvo}=80 μm, at z_{galvo}=±40 μm, ±30 μm, ±20 μm, ±10 μm, and 0 μm.

The two-color ICHLLS system is driven by similar physical principals as the single wavelength IHLLS system, as described with reference to FIGS. 2-5D, and EQs. 1-4. The system calibration was performed with one diffractive lens, IHLLS-1L, of focal lengths, f_{SLM-488}=400 mm, and f_{SLM-561}=415 mm respectively for each wavelength of radiation. A sample scan is then performed using two diffractive lenses with randomly selected pixels on the camera, for each wavelength, with focal lengths f_{d1-488}=220 mm, f_{d2-488}=2356 mm, and f_{d1-561}=228 mm and f_{d2}-561=2444 mm. The physical distances between each sequential optical component and the focal distances for the two excitation wavelengths, 488 nm and 561 nm, were calculated using the Opticstudio (Zemax, LLC). The multi-wavelength optical system was designed such that the height of the two beams generated by the lenses for each focal length was equal in size at the camera plane providing significant overlap of radiation for performing ICHLLS imaging.

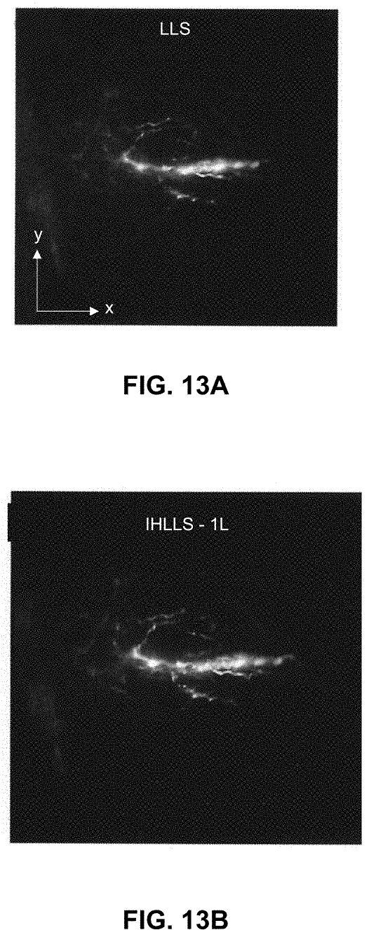

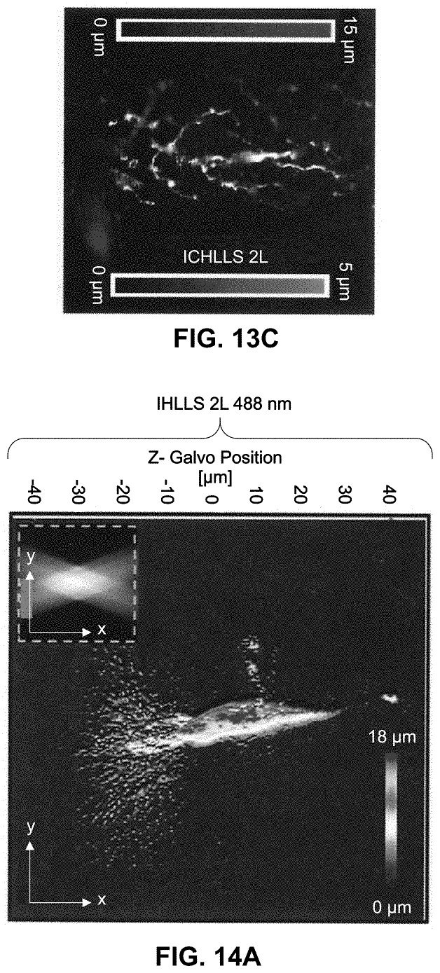

FIGS. 13A-13C are tomographic images obtained by using multi-wavelength IHLLS as described herein. FIG. 13A is an image of a neuron obtained using conventional LLS with two radiation wavelengths, FIG. 13B is an image obtained using multi-wavelength IHLLS with one diffractive lens superimposed on the SLM 1002, and FIG. 13C is an image obtained using multi-wavelength IHLLS with two diffractive lenses superimposed on the SLM 1002. The images of FIGS. 13A-13C were obtained using 300 galvonometer steps in the z-direction (in and out of the plane of the page). The galvonometer was stepped in 0.1 μm increments through the focal plane of a 25× Nikon objective which was simultaneously moved the same distance with a piezo controller for a total displacement range of 30 μm. FIG. 13C is an image of the reconstructed phase at 9 galvonometer positions from z_{galvo}=±40 μm, and 0 μm. The scanning area in FIG. 13C was 208×208 μm², while the scanning area in the conventional LLS and IHLLS-1L without blurring was 54×54 μm².

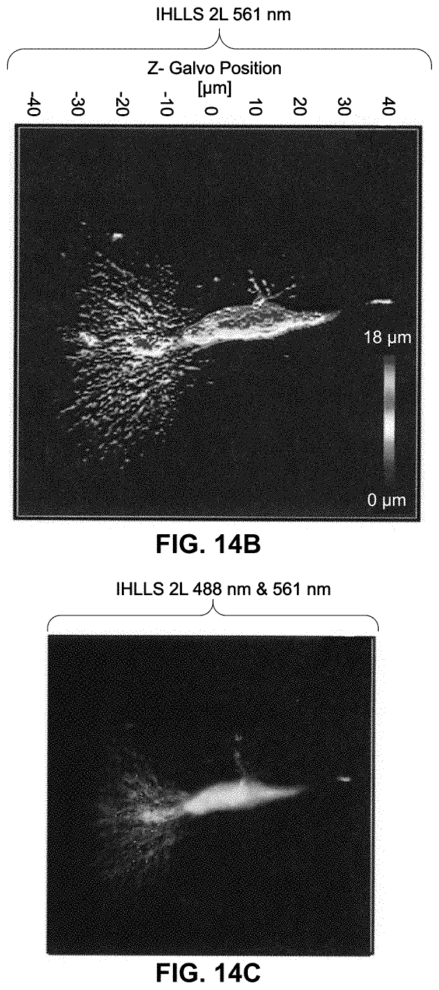

Combined with multicolor incoherent holographic imaging, the ICHLLS can provide rapid 3D validation of exogenous and endogenous subtle cellular differences that fluoresce at different wavelengths. Fluorophores can be attached to different markers of cell structure as desired to observe different chemical, structural, and biological changes and processes. As an example FIGS. 14A-14C are images of neuronal cells obtained using multi-wavelength IHLLS with two diffractive lenses superimposed on the SLM 1002. The images of FIGS. 14A-14C show reconstructed phase images at nine positions of the galvanometer, ±40 μm, ±30 μm, ±20 μm, ±10 μm, and 0 μm. FIG. 14A is an image obtained providing the 488 nm radiation to the sample, and FIG. 14B is an image obtained while providing the 561 nm radiation to the sample. FIG. 14C combines the phase reconstruction images of FIGS. 14A and 14B.

The use of IHLLS 2L, as described herein, enables the possibility of measuring changes in cell membrane potential with imaging resolution across the complex 3D structure of the neuron. Organelle and protein movement within cells changes the local refractive index which can be observed in real time on a time scale of seconds, hours, or days at an exposure time and laser intensity two times the amount of conventional LLS. Therefore, IHLLS 2L allows for the observation and detection of movements related to structural changes, axonal transport, and vesicle recycling. The use of IHLLS to detect and image electrical or structural changes of phase opens many new possibilities in imaging of neuronal and cellular activity. While measuring the biological function of neuronal tissues is one example, the IHLLS methods and system disclosed may be used in a number of industries and applications for measuring samples that require low illumination intensities and fast image capture times to observe behaviors of the sample, without damaging or affecting the sample. For example, the disclose IHLLS method and system may be beneficial for measuring chemical reactions, weakly bonded materials, electrically active materials, refractive index changes, The optical and mechanical design of the IHLLS system expands the applicability of the LLS, and other microscopy systems, and could open entirely new imaging modalities in all light sheet imaging instruments. The incoherent configuration could be added as an accessory or as an add-on feature to any existing system that provides galvanometer mirror beam scanning (e.g., Bessel and/or Gaussian beams.)

### Additional Aspects

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A microscopy system comprising: a source of radiation configured to provide radiation, the radiation having a (i) phase, (ii) amplitude), and (iii) Poynting vector, the Poynting vector having a direction indicative of a direction of propagation of the radiation; a modulator disposed along the direction of the Poynting vector, the modulator configured to modulate a phase of the radiation to generate a plurality of beams; a detector module disposed along the direction of the Poynting vector, the detector module configured to detect, at a detector plane of the detector module, the plurality of beams, the detector module further configured to generate a signal indicative of an interference pattern of the plurality of beams; and a processor communicative coupled to the detector module, the processor configured to receive the signal indicative of the interference pattern, and further configured to generate a holographic image from the signal.

2. A microscopy system according to aspect 1, wherein the modulator comprises a spatial light modulator (SLM).

3. A microscopy system according to either aspect 1 or 2, wherein the plurality of beams comprises two beams having a phase offset from each other of 0°, 90°, 180°, or 270°.

4. A microscopy system according to any of aspects 1 to 3, wherein the radiation comprises a Bessel beam.

5. A microscopy system according to any of aspects 1 to 4, wherein the modulator is further configured to modulate the phase of the radiation to correct for aberrations and phase distortions of the radiation due to optical elements.

6. A microscopy system according to any of aspects 1 to 5, wherein to modulate the phase of the radiation to generate a plurality of beams, the modulator is configured to: modulate the radiation to form a time-series of four beam pairs, wherein each beam pair of the time-series of four beam pairs includes two spatiotemporally overlapped beams, with the first beam pair having a phase offset of 0°, the second beam pair having a phase offset of 90°, the third beam pair having a phase offset of 180°, and the fourth beam pair having a phase offset of 270°.

7. A microscopy system according to any of aspects 1 to 6, wherein to generate a holographic image, the processor is further configured to: determine, from the signal indicative of the interference pattern, a complex amplitude of the interference pattern of the plurality of beams; reconstruct three-dimensional information from the complex amplitude of the interference pattern; and generate a holographic image from the three-dimensional information.

8. A microscopy system according to any of aspects 1 to 7, wherein the radiation comprises incoherent radiation.

9. A microscopy system according to any of aspects 1 to 8, further comprising a first magnification element disposed before the modulator along the direction of the Poynting vector, the first magnification element configured to magnify the radiation according to an active area of the modulator.

10. A microscopy system according to aspect 9, wherein the first magnification element comprises one of a lens, a mirror, a spatial light modulator, a telescope, or an objective.

11. A microscopy system according to any of aspects 1 to 10, further comprising a second magnification element disposed after the modulator along the direction of the Poynting vector, the second magnification element configured to magnify the plurality of beams according to a detection area of the detector module.

12. A microscopy system according to aspect 11, wherein the second magnification element comprises one of a lens, a mirror, a spatial light modulator, a telescope, or an objective.

13. A microscopy system according to any of aspects 1 to 12, further comprising a wavelength filter disposed along the direction of the Poynting vector, the wavelength filter configured to filter the radiation to attenuate a band of wavelengths of the radiation.

14. A microscopy system according to any of aspects 1 to 13, further comprising a polarizer disposed along the direction of the Poynting vector, the polarizer configured to polarize the radiation to filter out polarizations of the radiation.

15. A microscopy system according to any of aspects 1 to 14, further comprising, a radiation source configured to provide radiation to a sample, to perform imaging of the sample; and a microscope objective positioned at a first distance from the sample, the microscope objective configured to collect the radiation from the sample, the microscope objective further being operatively coupled to the modulator to provide the radiation to the modulator.

16. A microscopy system according to aspect 15, further comprising: an actuator physically coupled to the microscope objective, the actuator configured to alter the distance between the microscope objective and the sample;

17. A microscopy system according to aspect 16, wherein the actuator is a galvanometer configured to alter the position of the microscope objective.

18. A microscopy system according to any of aspects 1 to 17, wherein the modulator is configured to modulate the radiation according to two diffractive lenses superimposed on an active area of the modulator.

19. A microscopy system according to any of aspects 1 to 18, wherein the radiation source is a light sheet microscope.

20. An apparatus comprising: a light sheet microscope configured to provide radiation to the apparatus of any one of aspects 1 to 18.

21. A method for performing holographic microscopy, the method comprising:

providing, to a modulator, radiation having a (i) phase, (ii) amplitude), and (iii) Poynting vector; modulating, by the modulator, the phase of the radiation to generate a plurality of beams; detecting, at a detection plane of a detector module, the plurality of beams; generating, by the detector module, a signal indicative of an interference pattern of the plurality of beams; and generating, by a processor, a holographic image from the signal indicative of the interference pattern.

22. A method according to aspect 21, wherein the modulator comprises a spatial light modulator (SLM).

23. A method according to either aspect 21 or 22, wherein the plurality of beams comprises two beams having a phase offset from each other of 0°, 90°, 180°, or 270°.

24. A method according to any of aspects 21 to 23, wherein the radiation comprises a Bessel beam.

25. A method according to any of aspects 21 to 24, wherein the modulator is further configured to modulate the phase of the radiation to correct for aberrations and phase distortions of the radiation due to optical elements.

26. A method according to any of aspects 21 to 25, wherein modulating the radiation to generate a plurality of beams comprises: modulating the radiation to form a time-series of four beam pairs, wherein each beam pair of the time-series of four beam pairs includes two spatiotemporally overlapped beams, with the first beam pair having a phase offset of 0°, the second beam pair having a phase offset of 90°, the third beam pair having a phase offset of 180°, and the fourth beam pair having a phase offset of 270°.

27. A method according to any of aspects 21 to 26, wherein to generate a holographic image, the method further comprises: determining, by the processor, and from the signal indicative of the interference pattern, a complex amplitude of the interference pattern of the plurality of beams; reconstructing, by the processor, three-dimensional information from the complex amplitude of the interference pattern; and generating, by the processor, a holographic image from the three-dimensional information.

28. A method according to any of aspects 1 to 27, wherein the radiation comprises incoherent radiation.

29. A method according to any of aspects 21 to 28, further comprising magnifying, before receiving the radiation at the modulator, the radiation according to an active area of the modulator.

30. A method according to aspect 29, wherein magnifying the radiation according to an active area of the modulator is performed by one of a lens, a mirror, a spatial light modulator, a telescope, or an objective.

31. A method according to any of aspects 21 to 30, further comprising magnifying, after modulating the phase of the radiation, the plurality of beams according to an active detection area of the detector module.

32. A method according to aspect 31, wherein magnifying the plurality of beams according to an active detection area of the detector module is performed by one of a lens, a mirror, a spatial light modulator, a telescope, or an objective.

33. A method according to any of aspects 21 to 32, further comprising filtering, by a wavelength filter, the radiation to attenuate a band of wavelengths of the radiation.

34. A method according to any of aspects 21 to 33, further comprising polarizing, by a polarizer, the radiation to filter out polarizations of the radiation.

35. A method according to any of aspects 21 to 34, further comprising, before receiving the radiation by the modulator, providing the radiation to a sample, to perform imaging of the sample.

36. A method according to 35, further comprising: collecting, by a microscope objective positioned at a first distance from the sample, the radiation from the sample; altering, by an actuator, the distance between the microscope objective and the sample from the first distance to a second distance, wherein the second distance is a different distance than the first distance; and collecting, by the microscope objective positioned at the second distance, the radiation from the sample.

37. A method according to aspect 36, wherein the actuator is a galvanometer configured to alter the position of the microscope objective.

38. A method according to any of aspects 21 to 37, wherein modulating the phase of the radiation comprises modulating the phase of the radiation according to two diffractive lenses superimposed on an active area of the modulator.

I claim:

1. A microscopy system comprising:
a source of radiation configured to provide radiation, the radiation having a (i) phase, (ii) amplitude, and (iii) Poynting vector, the Poynting vector having a direction indicative of a direction of propagation of the radiation;
a modulator disposed along the direction of the Poynting vector, the modulator configured to modulate a phase of the radiation to generate a plurality of beams;
a detector module disposed along the direction of the Poynting vector, the detector module configured to detect, at a detector plane of the detector module, the plurality of beams, the detector module further configured to generate a signal indicative of an interference pattern of the plurality of beams; and
a processor communicatively coupled to the detector module, the processor configured to receive the signal indicative of the interference pattern, and further configured to generate a holographic image from the signal.

2. A microscopy system according to claim 1, wherein the modulator comprises a spatial light modulator (SLM).

3. A microscopy system according to claim 1, wherein the source of radiation provides radiation at more than one wavelength.

4. A microscopy system according to claim 3, wherein the modulator is configured to superimpose a plurality of lenses on an active area of the modulator, each lens of the plurality of lenses having a focal length dependent on a corresponding wavelength of radiation, to focus each of the wavelengths of radiation at a same focal distance.

4. A microscopy system according to claim 1, wherein the plurality of beams comprises two beams having a phase offset from each other of 0°, 90°, 180°, or 270°.

5. A microscopy system according to claim 1, wherein the modulator is further configured to modulate the phase of the radiation to correct for aberrations and phase distortions of the radiation due to optical elements.

6. A microscopy system according to claim 1, wherein to modulate the phase of the radiation to generate a plurality of beams, the modulator is configured to:
modulate the radiation to form a time-series of four beam pairs, wherein each beam pair of the time-series of four beam pairs includes two spatiotemporally overlapped beams, with the first beam pair having a phase offset of 0°, the second beam pair having a phase offset of 90°, the third beam pair having a phase offset of 180°, and the fourth beam pair having a phase offset of 270°.

7. A microscopy system according to claim 1, wherein to generate a holographic image, the processor is further configured to:
determine, from the signal indicative of the interference pattern, a complex amplitude of the interference pattern of the plurality of beams;
reconstruct three-dimensional information from the complex amplitude of the interference pattern; and
generate a holographic image from the three-dimensional information.

8. A microscopy system according to claim 1, wherein the radiation comprises incoherent radiation.

9. A microscopy system according to claim 1, further comprising a first magnification element disposed before the modulator along the direction of the Poynting vector, the first magnification element configured to magnify the radiation according to an active area of the modulator.

10. A microscopy system according to claim 9, wherein the first magnification element comprises one of a lens, a mirror, a spatial light modulator, a telescope, or an objective.

11. A microscopy system according to claim 1, further comprising a second magnification element disposed after the modulator along the direction of the Poynting vector, the second magnification element configured to magnify the plurality of beams according to a detection area of the detector module.

12. A microscopy system according to claim 11, wherein the second magnification element comprises one of a lens, a mirror, a spatial light modulator, a telescope, or an objective.

13. A microscopy system according to claim 1, further comprising a wavelength filter disposed along the direction of the Poynting vector, the wavelength filter configured to filter the radiation to attenuate a band of wavelengths of the radiation.

14. A microscopy system according to claim 13, wherein the wavelength filter comprises a multi-wavelength bandpass filter configured to filter radiation at a plurality of center wavelengths.

15. A microscopy system according to claim 1, further comprising, a
radiation source configured to provide radiation to a sample, to perform imaging of the sample; and
a microscope objective positioned at a first distance from the sample, the microscope objective configured to collect the radiation from the sample, the microscope objective further being operatively coupled to the modulator to provide the radiation to the modulator.

16. A microscopy system according to claim 15, further comprising:
an actuator physically coupled to the microscope objective, the actuator configured to alter the distance between the microscope objective and the sample.

17. A microscopy system according to claim 16, wherein the actuator is a galvanometer configured to alter the position of the microscope objective.

18. A microscopy system according to claim 1, wherein the modulator is configured to modulate the radiation according to two diffractive lenses superimposed on an active area of the modulator.

19. A microscopy system according to claim 1, wherein the source of radiation is a light sheet microscope.

20. A method for performing holographic microscopy, the method comprising:
providing, to a modulator, radiation having a (i) phase, (ii) amplitude), and (iii) Poynting vector;
modulating, by the modulator, the phase of the radiation to generate a plurality of beams;
detecting, at a detection plane of a detector module, the plurality of beams;
generating, by the detector module, a signal indicative of an interference pattern of the plurality of beams; and
generating, by a processor, a holographic image from the signal indicative of the interference pattern.
